(19) United States
(12) Patent Application Publication
(10) Pub. No.: US 2004/0114224 A1
(43) Pub. Date: Jun. 17, 2004

(54) Microscope array for fluorescence spectroscopy, especially fluorescence correlation spectroscopy

(76) Inventors: Rudolf Rigler, St-Sulpice (CH); Lars Edman, Stockholm (CH)

Correspondence Address: ROTHWELL, FIGG, ERNST & MANBECK, P.C., 1425 K STREET, N.W., SUITE 800, WASHINGTON, DC, 20005, US

(21) Appl. No.: 10/473,227

(22) PCT Filed: Mar. 27, 2002
(86) PCT No.: PCT/EP02/03453

(30) Foreign Application Priority Data
Mar. 28, 2001 (DE) 101 15 309.0

(51) Int. Cl. G02B 21/00

(52) U.S. Cl. 359/383; 359/368

(57) ABSTRACT

A microscope arrangement for fluorescence spectroscopy, especially fluorescence correlation spectroscopy, is proposed having at least two beam paths (38, 40, 50) that can be focused in each case onto a measuring volume, situated in a common measuring area of the microscope array, of a sample (12) to be investigated. At least one (50) of the beam paths (38, 40, 50) is an illuminating beam path that leads from a light source (44) to the measuring area. At least one further (38, 40) of the beam paths (38, 40, 50) is, moreover, an observing beam path that leads from the measuring area to a photodetector (26, 36) providing a fluorescence detection signal. The microscope arrangement has at least one optical element (18, 20, 22, 28, 30, 48) that is arranged in one of the beam paths (38, 40, 50) and can be adjusted for the purpose of setting the focus of this beam path (38, 40, 50). Provided according to the invention is an electronic actuating and control device (52) that responds to the fluorescence detection signal, is connected in an actuating fashion to the optical element (18, 20, 22, 28, 30, 48) and is designed to adjust the optical element (18, 20, 22, 28, 30, 48) as a function of the fluorescence detection signal in order to set the focus of the relevant beam path (38, 40, 50). A highly precise focal adjustment of the microscope arrangement is possible in this way.

The invention relates to a microscope arrangement for fluorescence spectroscopy, especially fluorescence correlation spectroscopy.

Fluorescence spectroscopy is a method that permits the identification of specific analytes in a sample under investigation. The sample under investigation can be any desired liquid sample; as a rule, this is a biological sample, for example a body fluid such as blood, serum plasma, urine, saliva etc., or a molecular biological reaction batch, for example a sequencing batch. The analytes may be substances with a low molecular weight, such as medicaments, hormones, nucleotides, metabolites etc., or substances with a high molecular weight, such as proteins, sugars, nucleic acids etc., viruses or cells, such as bacterial cells. In order to be able to identify the relevant analytes, they are labeled with reagents which carry fluorophores and emit fluorescence signals when irradiated by light, in particular laser light, these signals being detected and evaluated. In fluorescence correlation spectroscopy, auto- or/and cross-correlations of the detected fluorescence signals are then evaluated. Further information about fluorescence spectroscopy and, in particular, about fluorescence correlation spectroscopy can be found, for example, in EP 0 679 251 B1 and an article entitled “Sorting single molecules: Application to diagnostics and evolutionary biotechnology” by M. Eigen and R. Rigler, published in Volume 91 of Proc. Natl. Acad. Sci. USA, pages 5740 to 5747, June 1994.

Use is made for fluorescence spectroscopic investigations of microscopes that are intended to be able to focus onto a very small partial volume of the sample—the measuring volume. A very small measuring volume, for example in the femtoliter range, is targeted so that the fluorescing molecules do not bleach out owing to excessively intensive and long irradiation with light and falsify the measurements. In the case of small measuring volumes of this type, an exactly confocal setting of the microscope used is of great importance in order to ensure sufficiently high signal-to-noise ratios. Confocality means in this case that the illuminating focus and observing focus of the microscope coincide exactly. This is difficult to achieve, however, because owing precisely to the tiny size of the measuring volume even the slightest erroneous settings can be enough to lead to afocality between the illuminating focus and observing focus. The matter becomes even more complicated when the microscope is designed with a plurality of detectors and the observing focus of each of these detectors is to coincide exactly with the measuring volume.

It is the object of the invention to permit exact setting of the focus in the case of a microscope for fluorescence spectroscopy.

In achieving this object, the invention proceeds from a microscope arrangement for fluorescence spectroscopy, especially fluorescence correlation spectroscopy, having at least two beam paths that can be focused onto a measuring volume, situated in a common measuring area of the microscope arrangement, of a sample to be investigated, at least one of the beam paths being an illuminating beam path that leads from a light source to the measuring area, at least one further of the beam paths being an observing beam path that leads from the measuring area to a photodetector providing a fluorescence detection signal, and the microscope arrangement having at least one optical element that is arranged in one of the beam paths and can be adjusted for the purpose of setting the focus of this beam path.

According to the invention, the microscope arrangement in this case comprises an electronic actuating and control device that responds to the fluorescence detection signal, is connected in an actuating fashion to the optical element and is designed to adjust the optical element as a function of the fluorescence detection signal in order to set the focus of the relevant beam path.

In the case of the solution according to the invention, the fluorescence detection signal serves as feedback variable with the aid of which the actuating and control device determines any possible required actuation for the optical element. It has emerged that the fluorescence detection signal can be used to obtain a highly accurate setting of the focus of each beam path of the microscope arrangement.

The optical element can be of any desired type as long as its spatial position influences the position of the object-side focus of the relevant beam path, for example a lens, a diaphragm or a mirror. In the case of an illuminating beam path, the light source can also serve directly as adjustable optical element, or in the case of an observing beam path the photodetector that detects the excited light pulses can serve as adjustable optical element. It is possible not only for a single optical element to be adjustable in each beam path, but two or more optical elements can be provided which can be adjusted independently of one another in order to set the focus of the relevant beam path.

In a preferred development of the invention, the actuating and control device is designed to adjust the optical element as a function of a correlation signal derived from the fluorescence detection signal in order to set the focus of the relevant beam path. Here, in order to set the focus of an illuminating beam path and an observing beam path relative to one another, the actuating and control device can be designed to adjust at least one optical element, arranged in the illuminating beam path, or/and to adjust at least one optical element, arranged in the observing beam path, doing so as a function of an autocorrelation signal that is derived by autocorrelation of the fluorescence detection signal of the photodetector arranged in the observing beam path. If, by contrast, the aim is for the focus of a first and a second observing beam path to be set relative to one another, the actuating and control device can be designed to adjust at least one optical element, arranged in the first observing beam path, or/and to adjust at least one optical element, arranged in the second observing beam path, doing so as a function of a cross-correlation signal that is derived by cross-correlation of the fluorescence detection signals of the photodetectors arranged in the two observing beam paths.

A few exemplary embodiments of the microscope arrangement according to the invention are explained below in more detail with the aid of the attached drawings, in which:

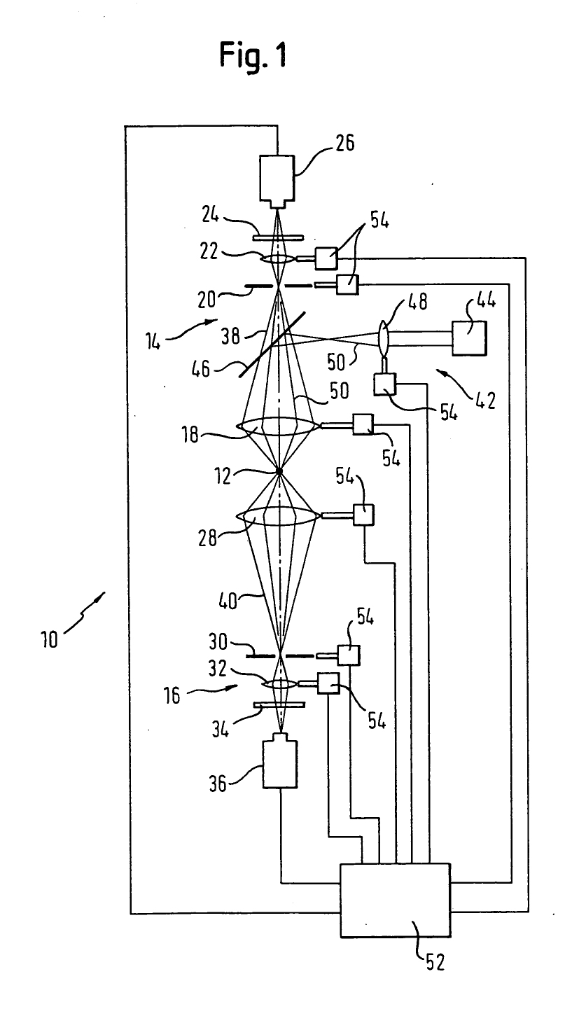

FIG. 1 is a schematic of a first exemplary embodiment of the microscope arrangement,

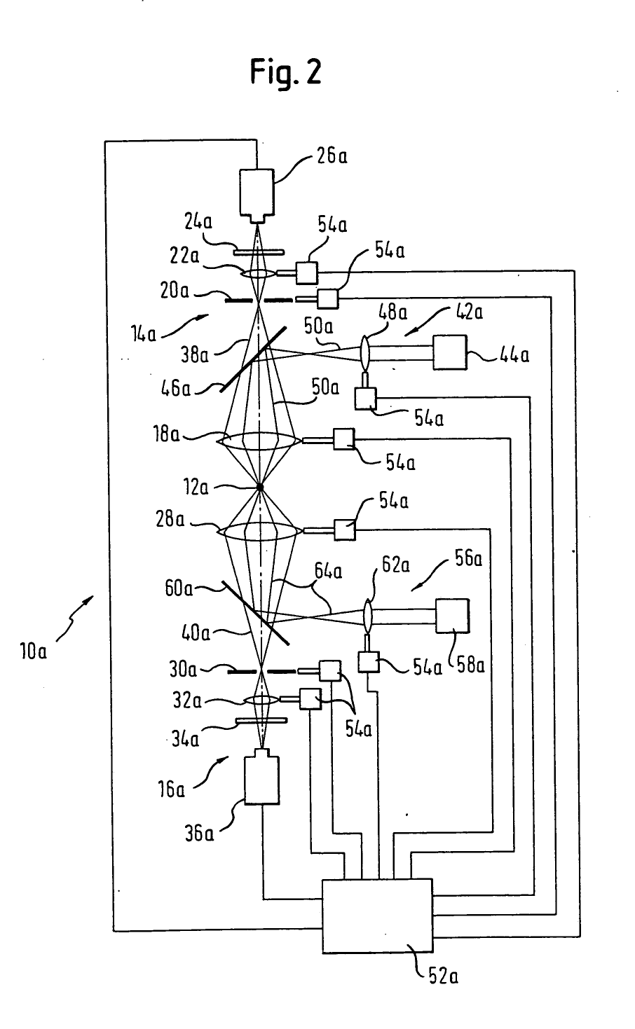

FIG. 2 is a schematic of a second exemplary embodiment of the microscope arrangement,

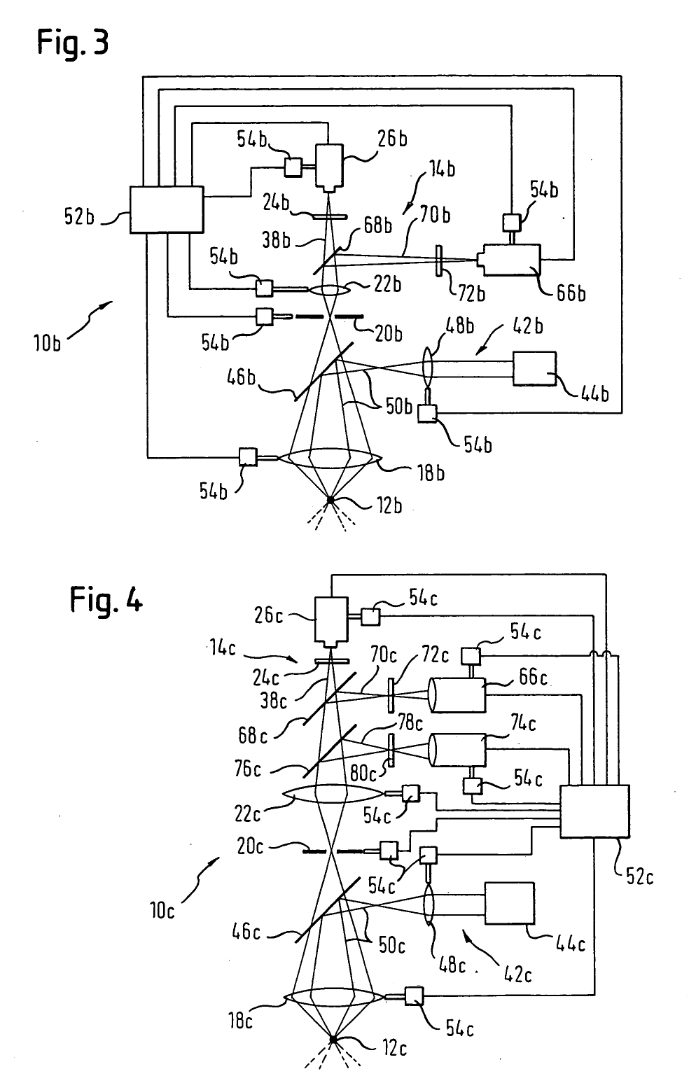

FIG. 3 is a schematic of a third exemplary embodiment of the microscope arrangement, and

FIG. 4 is a schematic of a fourth exemplary embodiment of the microscope arrangement.

The microscope arrangement shown in FIG. 1 is designed as a double microscope 10 that serves the purpose of fluorescence spectroscopic examination of a sample, arranged at 12 but not illustrated in more detail, for example a blood sample, which is to be investigated for the presence of specific analytes, for example pathogenic viruses or DNA strands. The designation double microscope relates to a configuration of the microscope arrangement with two optical observing subassemblies 14, 16 that are arranged situated opposite one another with reference to the sample 12 to be investigated and which permit the sample 12 to be investigated to be observed from two different sides. The observing subassembly 14 has an objective lens 18, a pinhole diaphragm 20 and, if appropriate, further optical elements (lenses, filters, diaphragms or the like), which serve the purpose in their totality of imaging onto a photodetector 26 a small partial volume, denoted as measuring volume, of the sample 12 to be investigated. In the present exemplary case of FIG. 1, these further optical elements comprise a lens 22 and a filter 24. The distance of the objective lens 18 from the sample 12 to be investigated can be less than 1 mm; however, it can also be greater than 1 mm. There is no limitation as to distance in this regard. The observing subassembly 16, preferably of the same structural design, correspondingly has an objective lens 28, a pinhole diaphragm 30 and, if appropriate, further optical elements (here, a lens 32 and a filter 34) which image the measuring volume onto a photodetector 36. Each of the observing subassemblies 14, 16 defines an observing beam path that runs from the measuring volume to the respective detector 26 or 36 and is denoted by 38 or 40, respectively, in FIG. 1.

The double microscope 10 further comprises an illuminating subassembly 42, which serves the purpose of providing an illuminating beam directed onto the measuring volume. It comprises a laser source 44, a semitransparent (dichroic) mirror 46, which is arranged in one of the observing beam paths 38, 40 (here, in the observing beam path 38) and by means of which the laser beam emitted by the laser source 44 is deflected in the direction of the measuring volume, and, if appropriate, further optical elements for influencing the laser beam. These further optical elements comprise in the present exemplary case at least one lens 48 which serves the purpose of prefocusing the laser beam. After being deflected by the mirror 46, the laser beam strikes the objective lens 18, from where it is focused onto the measuring volume of the sample 12 to be investigated. The illuminating subassembly 42 thus defines—together with the objective lens 18—an illuminating beam path of the double microscope 10 that leads from the laser source 44 to the measuring volume. This illuminating beam path is denoted by 50 in FIG. 1.

The laser beam striking the measuring volume excites to fluorescence fluorophores that are located therein (free fluorophores or ones bound to the targeted analytes). Light pulses that are recorded by the detectors 26, 36 are generated in the process. The detectors 26, 36 can respond to identical or different fluorescence wavelengths. An electronic evaluation and control unit 52 connected to the detectors 26, 36 evaluates the fluorescence detection signals supplied by the detectors. The identification of the targeted analytes is preferably performed by autocorrelation and/or cross-correlation of the fluorescence detection signals.

Microscope arrangements in the case of which the measuring volume situated at the focus of a laser beam is simultaneously imaged exactly onto a detector are usually termed confocal. Confocal microscope arrangements are known in specialist circles. For example, reference is made to EP 0 679 251 B1, from which design details relating to a confocal double microscope may be gathered.

In order to obtain exact confocality with the double microscope 10 of FIG. 1, the illuminating focus, that is to say the focus of the laser beam, must coincide exactly with the observing focus of each of the observing beam paths 38, 40. At the same time, the foci of the two observing beam paths 38, 40 are to be exactly coincident so that different partial volumes of the sample 12 to be investigated are not observed by the two detectors 26, 36. The evaluation and control unit 52 is designed for the purpose of undertaking to set the focus of each observing and illuminating beam path automatically to meet the previous criteria, specifically as a function of the fluorescence detection signals supplied by the detectors 26, 36. The setting of the focus of the beam paths 38, 40, 50 is performed, for example, in such a way that firstly the illuminating beam path 50 and the observing beam path 38 are tuned to one another in terms of focus, and subsequently the focus of the observing beam path 40 is rendered coincident with the focus of the observing beam path 38.

For the purpose of setting the focus of the relevant beam path, at least one optical component can be adjusted in each of the beam paths 38, 40, 50 by means of an actuator 54, controlled by the evaluation and control unit 52, in at least one spatial direction, but if desired also in two or even three mutually orthogonal spatial directions. This component can be adjustable independently of the other optical components of the relevant beam path. However, it is also conceivable for at least a portion of the remaining optical components of the relevant beam path to be coupled in terms of movement to the adjustable component in such a way that upon adjustment of one component this portion of the remaining components also experiences an adjustment. In particular, two or more optical components that can be adjusted independently of one another in each case by means of an actuator 54 can be arranged in one beam path. As far as the observing beam path 38 is concerned, by way of example the objective lens 18 and the pinhole diaphragm 20 can be adjustable independently of one another in FIG. 1 by means of one actuator 54 each. It is easy to understand that the spatial position of the object-side focus, seen from the detector 26, of the observing beam path 38 can be influenced by adjusting each of these two components. In addition, the objective lens 18 is situated in the illuminating beam path 50; in addition to the focus of the observing beam path 38, it therefore follows that an adjustment of the objective lens 18 would simultaneously also influence the focus of the illuminating beam path 50. Furthermore, in order to be able to set the focus of the illuminating beam path 50 independently of the focus of the observing beam path 38, at least one optical component that exclusively influences the illuminating beam path 50 in terms of focus can be adjusted by means of an actuator 54 independently of the objective lens 18. This is the prefocusing lens 48 in the case of FIG. 1. This lens can preferably be adjusted along the illuminating beam path 50, and also transverse to the latter (that is to say, upward and downward in FIG. 1).

It is to be noted that FIG. 1 shows only examples of adjustable components. In principle, arbitrary optical components of a beam path can be adjustable independently of or as a function of other components in order to set the focus. In particular, it is conceivable for the detectors 26, 36 or/and the laser source 44 to be adjustable. Of course, it is also possible in addition for the lenses 22, 32 or/and the mirror 46 to be adjustable.

Using the signals supplied by the detectors, the evaluation and control unit 52 preferably counts the events detected per molecule, and in the course of setting the foci of the beam paths 38, 40, 50 controls the actuators 54, preferably as a function of correlation signals that it determines from the detector signals. It uses the fluorescence detection signal supplied by the detector 26 to determine, in particular, an autocorrelation signal of first or/and higher order for the purpose of rendering coincident the foci of the illuminating beam path 50 and the observing beam path 38. As a function of the autocorrelation signal, the evaluation and control unit 52 then drives the actuators 54 in a suitable fashion in order to adjust at least a portion of the adjustable optical components of the observing beam path 38 or/and of the illuminating beam path 50. This is preferably performed as a function of the amplitude and the half-value time of the correlation. When the autocorrelation signal assumes a non-vanishing value, in particular has a significant peak, the foci of the observing beam path 38 and the illuminating beam path 50 coincide.

In order then to bring the focus of the other observing beam path 40 into coincidence with the focus of the observing beam path 38, the evaluation and control unit 52 uses the fluorescence detection signals of the two detectors 26, 36 to determine a cross-correlation signal of first or/and higher order. As a function of this cross-correlation signal, in particular once again dependent on the amplitude and half-value time of the cross-correlation, it then adjusts at least a portion of the adjustable optical components of the observing beam path 40 until the cross-correlation signal assumes a non-vanishing value, in particular has a significant peak. The foci of the observing beam paths 38, 40 coincide as soon as the cross-correlation signal exhibits such behavior.

In a preferred practical embodiment of the double microscope of FIG. 1, the object lenses 18, 28 and the pinhole diaphragms 20, 30 are fixed. By contrast, the lenses 22, 32 are adjustable. The lens 48 in the illuminating beam path 50 is, furthermore, adjustable.

Correlation functions of higher order can be used for further optimization of the adjusting algorithm based on feedback. For example, imagine that the fluorescing molecules used to label the analytes emit light pulses of different (more than two) emission wavelengths. When the two detectors 26, 36 respond to mutually different wavelengths, it is possible to detect the coincidence between the foci of the two observing beam paths 38, 40 via a polychromatic correlation function of higher order.

The actuators 54 can be of any desired design. For example, they can be piezoelectric actuators or mechanical micro wormdrives.

In the further figures, identical components or ones that act identically are provided with the same reference numerals as in FIG. 1, but supplemented by a small letter. In order to avoid repetitions, reference is made to the preceding statements relating to FIG. 1 for the purpose of explaining these components. The aim below is to consider only differences from the embodiment of FIG. 1.

In the exemplary embodiment of FIG. 1, the sample to be investigated was irradiated with light only from one side. FIG. 2 shows an exemplary embodiment in which the sample 12a to be investigated is irradiated with light from two opposite sides. Provided for this purpose is a further illuminating subassembly 56a that has a laser source 58a, a dichroic mirror 60a arranged in the observing beam path 40a and, if appropriate, further optical elements for influencing the laser beam of the laser source 58a. These further optical elements comprise at least one prefocusing lens 62a in the present exemplary case. After being deflected by the mirror 60a, the laser beam of the laser source 58a strikes the objective lens 28a, from where it is focused onto the measuring volume of the sample 12a to be investigated. Together with the objective lens 28a, the illuminating subassembly 56a defines a further illuminating beam path of the double microscope 10a, which leads from the laser source 58a to the measuring volume and is denoted by 64a in FIG. 2.

The focus of this illuminating beam path 64a is to be set optimally such that it coincides exactly with the foci of the illuminating beam path 50a and the observing beam paths 38a, 40a. It is possible for this purpose to use an actuator 54a to adjust at least one optical component of the double microscope 10a that focally influences exclusively the illuminating beam path 64a. This is the prefocusing lens 62a in FIG. 2. It goes without saying that it is also possible alternatively or additionally for the laser source 58a or/and the mirror 60a to be adjustable by means of such an actuator 54a.

The sequence in which the individual beam paths 38a, 40a, 50a, 64a of the double microscope 10a are set focally can, for example, be such that firstly—as in the case of the exemplary embodiment of FIG. 1—the beam paths 38a, 40a and 50a are adjusted relative to one another, and then the focus of the illuminating beam path 64a is made to coincide with the focus of the observing beam path 40a, this being done, in turn, by using the autocorrelation of first or/and higher order of the fluorescence detection signal of the detector 36a.

The two laser sources 44a, 58a can emit laser light of different wavelengths. Admittedly, the laser sources 44a, 58a are not excluded from emitting light of the same wavelength. One modification of FIG. 2 can consist in omitting one of the laser sources 44a, 58a and splitting the light of the remaining laser source. Each part of the laser beam emitted by this single laser source is then fed into one of the illuminating beam paths 50a, 64a.

In the exemplary embodiment of FIG. 3, the observing subassembly 14b comprises not only the detector 26b but, furthermore, a second detector 66b, the light emitted by the fluorescing molecules of the sample 12b to be investigated being deflected partially to the detector 66b by means of a dichroic mirror 68b arranged in the observing beam path 38b downstream of the pinhole diaphragm 20b and downstream of the lens 22b. A further observing beam path is defined in this way, which is denoted by 70b in FIG. 3 and runs from the sample 12b to be investigated up to the mirror 68b and from there to the detector 66b. Further optical elements such as, for example, a filter 72b can be arranged in the part of the observing beam path 70b that runs separately from the observing beam path 38b. The detectors 26b, 66b preferably detect light of different wavelengths.

One of the observing beam paths 38b, 70b and the illuminating beam path 50b can, for example, firstly be tuned to one another—as in the exemplary embodiment of FIG. 1—for the purpose of focal adjustment of the microscope 10b. The other observing beam path can then be tuned focally to the illuminating beam path 50b by means of autocorrelation or/and focally to one observing beam path by means of cross-correlation. The two detectors 26b, 66b can respectively be adjustable by means of an actuator 54b in FIG. 3 for the purpose of setting the foci of the two observing beam paths 38b, 70b independently of one another. In a preferred embodiment, it is also possible for only one of the two detectors 26b, 66b to be adjustable, while the other is fixed. Preferably only the lens 22b of the components 18b, 20b, 22b is adjustable—although an actuator 54b is depicted in FIG. 3 relative to each of these components—whereas the objective lens 18b and the pinhole diaphragm 20b are preferably fixed.

In the exemplary embodiment of FIG. 4, the observing subassembly 14c even comprises three detectors preferably responding to different wavelengths, specifically a third detector 74c further to the detectors 26c, 66c. Said third detector detects light that is split out of the light emitted by the sample 12c to be investigated by means of a further dichroic mirror 76c arranged in the observing beam path 38c. An observing beam path 78c is thus defined that runs from the sample 12b to be investigated up to the mirror 76c and from there to the detector 74c. Further optical elements such as a filter 80c, for example, can be arranged in turn in the part of the observing beam path 78c that runs separately from the observing beam paths 38c, 70c.

In a way similar to the exemplary embodiment of FIG. 3, it is possible for the purpose of focal adjustment of the microscope 10c of FIG. 4 firstly, for example, to bring the foci of one of the observing beam paths 38c, 70c, 78c and the illuminating beam path 50c into coincidence. The two other observing beam paths can then respectively be tuned focally by means of autocorrelation to the illuminating beam path 50c or/and be tuned focally to the one observing beam path by means of cross-correlation. All the detectors 26c, 66c, 74c are respectively assigned an actuator 54b in FIG. 4 for the purpose of setting the foci of the three observing beam paths 38c, 70c, 78c independently of one another. However, it is preferred for only two of the detectors and the lens 22c to be adjustable.

Although the microscope arrangements of FIGS. 3 and 4 are respectively illustrated only as a single microscope, in which the sample to be investigated is observed only from one side, it goes without saying that they can also be designed as a double microscope in the case of which—as in FIGS. 1 and 2—observing means and, if desired, illuminating means, as well, are also provided on the opposite side of the sample to be investigated. This is indicated in FIGS. 3 and 4 by dashes below the sample to be investigated in each case. In particular, it is possible in this case to select a mirror-image configuration of the microscope. Moreover, it goes without saying that it is also possible in principle within the scope of the invention to conceive of multiple microscope arrangements in the case of which the sample to be investigated is observed from more than two sides.

1. A microscope arrangement for fluorescence spectroscopy, especially fluorescence correlation spectroscopy, having at least two beam paths (38, 40, 50) that can be focused onto a measuring volume, situated in a common measuring area of the microscope array, of a sample (12) to be investigated, at least one (50) of the beam paths (38, 40, 50) being an illuminating beam path that leads from a light source (44) to the measuring area, at least one further (38, 40) of the beam paths (38, 40, 50) being an observing beam path that leads from the measuring area to a photodetector (26, 36) providing a fluorescence detection signal, and the microscope arrangement having at least one optical element (18, 20, 22, 28, 30, 48) that is arranged in one of the beam paths (38, 40, 50) and can be adjusted for the purpose of setting the focus of this beam path (38, 40, 50), characterized by an electronic actuating and control device (52) that responds to the fluorescence detection signal, is connected in an actuating fashion to the optical element (18, 20, 22, 28, 30, 48) and is designed to adjust the optical element (18, 20, 22, 28, 30, 48) as a function of the fluorescence detection signal in order to set the focus of the relevant beam path (38, 40, 50).

2. The microscope arrangement as claimed in claim 1, characterized in that the actuating and control device (52) is designed to adjust the optical element (18, 20, 22, 28, 30, 48) as a function of a correlation signal derived from the fluorescence detection signal in order to set the focus of the relevant beam path (38, 40, 50).

3. The microscope arrangement as claimed in claim 2, characterized in that, in order to set the focus of an illuminating beam path (50) and an observing beam path (38) relative to one another, the actuating and control device (52) is designed to adjust at least one optical element (48), preferably arranged exclusively in the illuminating beam path (50), or/and to adjust at least one optical element (20, 22), preferably arranged exclusively in the observing beam path (38), doing so as a function of an autocorrelation signal that is derived by autocorrelation of the fluorescence detection signal of the photodetector (26) arranged in the observing beam path (38).

4. The microscope arrangement as claimed in claim 2 or 3, characterized in that, in order to set the focus of a first and a second observing beam path (38, 40) relative to one another, the actuating and control device (52) is designed to adjust at least one optical element (18, 20, 22), preferably arranged exclusively in the first observing beam path (38), or/and to adjust at least one optical element (28, 30, 32), preferably arranged exclusively in the second observing beam path (40), doing so as a function of a cross-correlation signal that is derived by cross-correlation of the fluorescence detection signals of the photodetectors (26, 36) arranged in the two observing beam paths (38, 40).
